(19) United States
(12) Patent Application Publication
(10) Pub. No.: US 2007/0071185 A1
(43) Pub. Date: Mar. 29, 2007

(54) Exchange apparatus and method of selecting voice storing area

(75) Inventors: Fumio Shibasaki, Sagamihara-shi (JP); Shuichi Sato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/474,289

(22) Filed: Jun. 26, 2006

(30) Foreign Application Priority Data
Jun. 30, 2005 (JP) 2005-191211

(51) Int. Cl. H04M 1/64

(52) U.S. Cl. 379/88.17

(57) ABSTRACT

According to one embodiment, an exchange apparatus comprising a first storing unit which includes a plurality of voice storing areas, a read unit which reads, from the first storing unit, information indicating one of the voice storing areas corresponding to a request to record a message, upon receiving the request from an information terminal, if the information terminal has a web function, a second storing unit which provides the information, indicating the one voice storing area and read by the read unit, with link information used for accessing the one voice storing area, to generate a web page and store the generated web page, and a transmission unit which generates URL information used to access the web page stored in the second storing unit, and transmit the web page to the information terminal.

### CROSS-REFERENCE TO RELATED APPLICATIONS

This application is based upon and claims the benefit of priority from Japanese Patent Application No. 2005-191211, filed Jun. 30, 2005, the entire contents of which are incorporated herein by reference.

### BACKGROUND

1. Field

One embodiment of the invention relates to an exchange apparatus for generating, as a web page, a selection menu for voice mailboxes and permitting an IP telephone terminal to access the web page for selecting the corresponding one of the mailboxes when, for example, voice is recorded in the corresponding voice mailbox through the IP telephone terminal. It also relates to a selection method for use in the apparatus.

2. Description of the Related Art

In general, to record a message sent by a telephone terminal to a telephone exchange, utilizing, for example, a voice mailbox, the telephone exchange emits a voice message to instruct the user of the telephone terminal to input the number assigned to the voice mailbox, and the user inputs the box number (see, for example, Jpn. Pat. Appln. KOKAI Publication No. 2004-356896).

In this technique, it is necessary for the user of the originator telephone terminal to beforehand know the number assigned to the voice mailbox. For instance, when a person has made a phone call to a certain representative number of a company to leave a message in a mailbox dedicated to a staff of the company, if they do not know the mailbox number, they cannot leave the message.

Further, even if a person has made a phone call to a representative number, using, for example, a recent IP telephone terminal with a web function, it is possible that only a device utilizing similar voice guidance is offered to the person, and hence the web function cannot effectively be used.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating a system that employs an exchange apparatus according to the invention;

FIG. 2 is a flowchart illustrating the procedure of generation of a web page, as a selection method for a voice mailbox;

FIG. 3 is a table illustrating the correspondence between destination numbers and voice mailbox group numbers;

FIG. 4 is a table illustrating the correspondence between voice mailbox group numbers and voice mailbox numbers;

FIG. 5 is a table illustrating the correspondence between voice mailbox numbers and attributes (explanation text) and stored in a voice-mailbox-number/voice-mailbox-attribute storing area incorporated in a storing unit; and

FIG. 6 is a view illustrating an example of a web page.

### DETAILED DESCRIPTION

Various embodiments according to the invention will be described hereinafter with reference to the accompanying drawings. In general, according to one embodiment of the invention, an exchange apparatus comprising: a first storing unit which includes a plurality of voice storing areas; a read unit which reads, from the first storing unit, information indicating one of the voice storing areas corresponding to a request to record a message, upon receiving the request from an information terminal, if the information terminal has a web function; a second storing unit which provides the information, indicating the one voice storing area and read by the read unit, with link information used for accessing the one voice storing area, to generate a web page and store the generated web page; and a transmission unit which generates URL information used to access the web page stored in the second storing unit, and transmit the web page to the information terminal.

An embodiment of the invention will be described in detail with reference to the accompanying drawings.

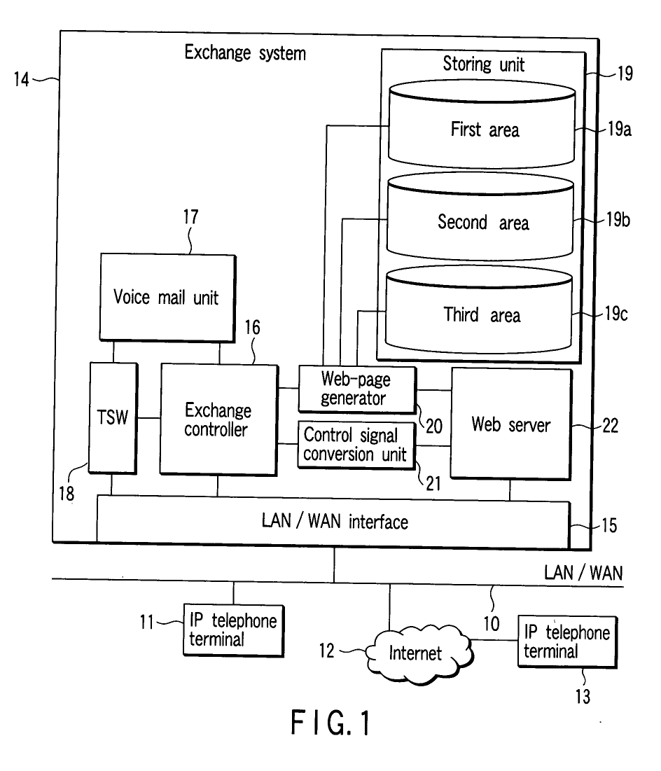

FIG. 1 is a block diagram illustrating a system that employs an exchange apparatus according to the invention. The system is used for, for example, voice mailbox services.

The system of FIG. 1 includes, for example, a local area network (LAN)/wide area network (WAN) 10. The LAN/WAN 10 is connected to a plurality of IP telephone terminals (information terminals) 11, IP telephone terminals 13 provided with software telephones via the Internet 12, etc. The IP telephone terminals 13 have a calling function and a media information processing function, and include personal digital assistances (PDAs) and personal computers (PCs), etc.

The LAN/WAN 10 is connected to a telephone exchange (hereinafter referred to as an “exchange system”) 14. The exchange system 14 records, in a voice mailbox (voice storing area), voice data sent from, for example, the IP telephone terminals 11 connected to the LAN/WAN 10. Further, the exchange system 14 can generate a downloadable list of voice mailboxes as a web page.

The exchange system 14 comprises a LAN/WAN interface 15 having an interfacing function for the LAN/WAN 10, an exchange controller 16 for controlling the calling operations of the IP telephone terminals 11 and 13 (hereinafter referred to as “IP telephone terminals 11”), a voice mail unit 17 having voice mail functions such as voice recording and reproduction, and a time switch (TSW) 18 for connecting the LAN/WAN interface 15 to the voice mail unit 17 to transfer voice data. The system 14 further comprises a storing unit 19 for storing various types of information concerning voice mailboxes, a web-page generator 20 for generating selection menus for voice mailboxes in the form of web pages, based on destination number information from the IP telephone terminals 11, a control signal conversion unit 21 for performing conversion of a control signal, and a web server 22 for transmitting, to the IP telephone terminals 11, uniform resource locators (URL) assigned to the generated web pages, and displaying the web pages and receiving selection results when the IP telephone terminals 11 access the exchange system.

The storing unit 19 includes first, second and third storing areas 19a, 19b and 19c.

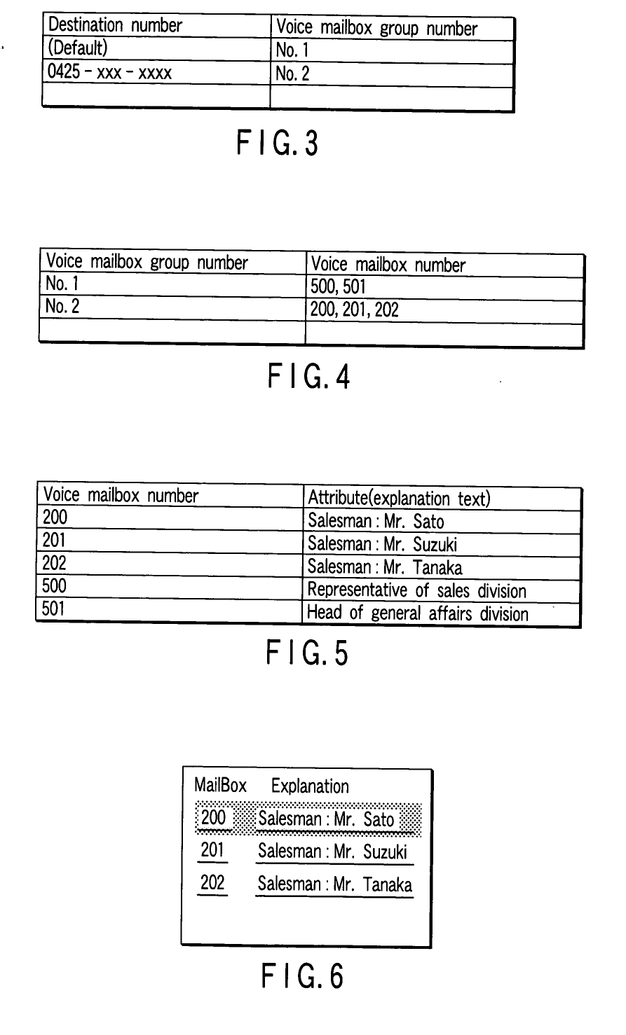

As shown in FIG. 3, the first storing area 19a of the storing unit 19 stores information indicating the correspondence between destination numbers and voice mailbox group numbers.

The second storing area 19a of the storing unit 19 stores information indicating the correspondence between voice mailbox group numbers and voice mailbox numbers.

The third storing area 19c of the storing unit 19 stores information indicating the correspondence between voice mailbox numbers and attributes (explanation text).

A description will now be given of a selection method for a voice mailbox as a voice storing area related to the exchange apparatus of the invention.

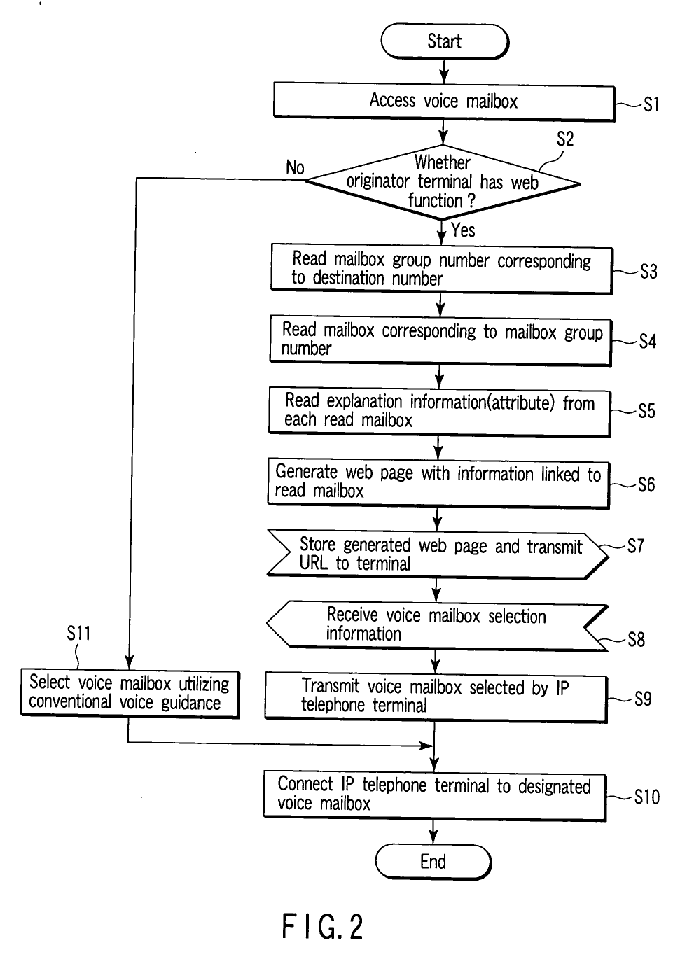

FIG. 2 is a flowchart illustrating the procedure of generating a web page used in the voice mailbox selection method.

When a certain IP telephone terminal (originator terminal) 11 has made a call to the exchange system 14 via the LAN/WAN 20 (step S1 in FIG. 2), the exchange controller 16 of the exchange system 14 determines whether the originator IP telephone terminal 11 has a web function (step S2 in FIG. 2).

If it is determined at step S2 that the originator IP telephone terminal 11 has a web function (Yes at step S2), the information concerning the correspondence between destination numbers and voice mailbox group numbers is read from the first storing area 19a of the storing unit 19 (step S3 in FIG. 2).

FIG. 3 is a table illustrating the correspondence between destination numbers and voice mailbox group numbers stored in the first storing area 19a.

When a certain IP telephone terminal 11 has made a call to the exchange system 14, the voice mailbox group number corresponding to the number assigned to the destination of the call is selected. For instance, when a default number (in general, a telephone number most frequently accessed, such as a pilot telephone number, is set as the default number) is accessed by the call, voice mailbox group number No. 1 is selected. Further, when a particular telephone number, such as 0425-xxx-xxxx, is called, voice mailbox group number No. 2 is selected.

After that, the information concerning the correspondence between voice mailbox group numbers and voice mailbox numbers is read from the second storing area 19b of the storing unit 19 (step S4 in FIG. 2).

FIG. 4 is a table illustrating the correspondence between voice mailbox group numbers and voice mailbox numbers stored in the second storing area 19b.

When a particular telephone number, such as 0425-xxx-xxxx, is called, voice mailbox group number No. 2 is selected, as is described above. Voice mailbox group number No. 2 corresponds to voice mailbox numbers 200, 201 and 202 in the case of FIG. 4, therefore voice mailbox numbers 200, 201 and 202 are selected.

Subsequently, the information concerning the correspondence between voice mailbox numbers and attributes (explanation text) is read from the third storing area 19c of the storing unit 19 (step S5 in FIG. 2).

FIG. 5 is a table illustrating the correspondence between voice mailbox numbers and attributes (explanation text) and stored in the third storing area 19c of the storing unit 19.

As described above, when voice mailbox numbers 200, 201 and 202 are selected, the attributes corresponding thereto are read. For example, information items “Salesman: Mr. Sato”, “Salesman: Mr. Suzuki” and “Salesman: Mr. Tanaka” are read from voice mail boxes with box numbers 200, 201 and 202, respectively.

The web-page generator 20 of the exchange system 14 generates a web page, using link information for accessing selected voice mailbox numbers 200, 201 and 202 and the attributes corresponding thereto (step S6 in FIG. 2).

The attribute information may be the name of the user (manager) of each voice mailbox, or the name of a representative, such as “Head of Sales Division”, as indicated by, for example, voice mailbox number 500 in FIG. 5.

FIG. 6 is a view illustrating an example of the generated web page.

Link information for accessing voice mailbox numbers 200, 201 and 202 is imparted in the web page. Similar information may be imparted to the attributes. When link information is imparted, the information in the web page is underlined as shown in FIG. 6.

The web-page generator 20 of the exchange system 14 stores the generated web page in, for example, the web server 22, and supplies a called IP telephone terminal (i.e., a destination terminal) 11 with URL information as access information for accessing the stored web page (step S7 in FIG. 2).

Upon receiving the URL information from the exchange system 14, the IP telephone terminal 11 accesses the generated web page, using its web function based on the received URL information. For example, when voice mailbox number 200 (Salesman: Mr. Sato) is selected as shown in FIG. 6, the control signal conversion unit 21 of the exchange system 14 receives information indicating the selected voice mailbox number (step S8 in FIG. 2).

The control signal conversion unit 21 of the exchange system 14 transmits the received information to the voice mail unit 17 via the exchange controller 16, i.e., the voice mail unit 17 is informed of the selected voice mailbox number (step S9 in FIG. 2).

The voice mail unit 17 connects the originator IP telephone terminal 11 to the voice mailbox corresponding to selected voice mailbox number 200 (Salesman: Mr. Sato), thereby recording a voice signal acquired by converting the voice from the IP telephone terminal 11 using the exchange controller 16 (step S10 in FIG. 2).

In contrast, if the exchange controller 16 of the exchange system 14 determines at step S2 that the originator IP telephone terminal 11 has no web function (No at step S2), it provides the user of the terminal 11 with conventional voice guidance to enable them to select the corresponding voice mailbox (step S11 in FIG. 2).

By virtue of the above-described mechanism, even if the user of an originator terminal does not know the voice mailbox number of a destination terminal, they can visually detect and select a desired voice mailbox to leave a message therein. Further, even if the exchange system include a large number of voice mailboxes, selection candidates can be restricted to a range sufficient for the user of an originator telephone to select a desired voice mailbox, thereby reducing the time and effort of the user required for selection.

The voice mail unit 17 and web server 22 incorporated in the exchange system 14 may be provided as elements separate from the exchange system 14.

The present invention is not limited to the above-described embodiments, but may be modified in various ways without departing from the scope. Various inventions can be realized by appropriately combining the structure elements disclosed in the embodiments. For instance, some of the disclosed structural elements may be deleted. Some structural elements of different embodiments may be combined appropriately.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An exchange apparatus comprising:
a first storing unit which includes a plurality of voice storing areas;
a read unit which reads, from the first storing unit, information indicating one of the voice storing areas corresponding to a request to record a message, upon receiving the request from an information terminal, if the information terminal has a web function;
a second storing unit which provides the information, indicating the one voice storing area and read by the read unit, with link information used for accessing the one voice storing area, to generate a web page and store the generated web page; and
a transmission unit which generates URL information used to access the web page stored in the second storing unit, and transmit the web page to the information terminal.

2. The exchange apparatus according to claim 1, wherein when the information terminal accesses the web page based on the URL information, and issues a request to record a message in the one voice storing area, the message is recorded in the one voice storing area.

3. The exchange apparatus according to claim 1, wherein the voice storing areas are voice mailboxes.

4. An exchange apparatus comprising:
a first storing unit which stores information items indicating a plurality of voice storing areas, a plurality of voice storing area group information items, a plurality of attribute information items corresponding to the respective voice storing areas, and destination number information corresponding to the voice storing area group information items, each of the voice storing area group information items indicating preset voice storing areas included in the voice storing areas;
a first read unit which reads one of the voice storing area group information items from the first storing unit, when a request to record a message in the voice recording areas is issued from an information terminal and if the information terminal has a web function, the one voice storing area group information item corresponding to the destination number information;
a second read unit which reads, from the first storing unit, information items indicating preset voice storing areas included in the voice storing areas and corresponding to the one voice storing area group information item read by the first read unit;
a third read unit which reads, from the first storing unit, those of the attribute information items which correspond to the information items indicating the preset voice storing areas and read by the second read unit;
a second storing unit which provides, to the information items indicating the preset voice storing areas and read by the second read unit, respective link information items used for accessing the preset voice storing areas, and generates and stores a web page in which the information items indicating the preset voice storing areas and provided with the link information items are related to those attribute information items corresponding to the preset voice storing areas; and
a transmission unit which generates URL information used for accessing the web page stored in the second storing unit, and transmits the generated URL information.

5. The exchange apparatus according to claim 4, wherein when the information terminal accesses the web page based on the URL information to request recording of a message in a selected one of the voice storing areas, the message is recorded in the selected voice recording area.

6. The exchange apparatus according to claim 4, wherein the voice storing areas are voice mailboxes.

7. The exchange apparatus according to claim 6, wherein each of the attribute information items indicates at least one of a name of a user and a name of a representative as a manager of a corresponding one of the voice mailboxes.

8. A voice-storing-area selection method for use in an exchange apparatus with a storing unit including a plurality of voice storing areas used to record voice from an information terminal, comprising:
determining whether the information terminal has a web function, upon receiving, from the information terminal, a request to record a message in the voice storing areas;
reading, from the storing unit, information indicating one of the voice storing areas corresponding to the request, if it is determined that the information terminal has the web function;
providing the information, indicating the one voice storing area and read by the read unit, with link information used for accessing the one voice storing area, to generate a web page and store the generated web page; and
generating URL information used for accessing the web page stored in the second storing unit, and transmitting the web page to the information terminal.

9. A voice-storing-area selection method for use in an exchange apparatus with a storing unit including a plurality of voice storing areas used to record voice from an information terminal, comprising:
storing information items indicating the voice storing areas, a plurality of voice storing area group information items, a plurality of attribute information items corresponding to the respective voice storing areas, and destination number information corresponding to the voice storing area group information items, each of the voice storing area group information items indicating preset voice storing areas included in the voice storing areas;
determining whether the information terminal has a web function, upon receiving, from the information terminal, a request to record a message in the voice storing areas;
reading one of the voice storing area group information items from the storing unit upon receiving the request from the information terminal, if it is determined that the information terminal has the web function, the one voice storing area group information item corresponding to the destination number information;
reading, from the storing unit, information items indicating preset voice storing areas included in the voice storing areas and corresponding to the read voice storing area group information item;
reading, from the storing unit, those of the attribute information items which correspond to read the information items indicating the preset voice storing areas;
providing, to the read information items indicating the preset voice storing areas, respective link information items used for accessing the preset voice storing areas, and generating and storing a web page in which the information items indicating the preset voice storing areas and provided with the link information items are related to those attribute information items corresponding to the preset voice storing areas; and
generating URL information used for accessing the stored web page, and transmitting the generated URL information.
